(19) United States
(12) Patent Application Publication
(10) Pub. No.: US 2006/0215992 A1
(43) Pub. Date: Sep. 28, 2006

(54) Recording and playing apparatus

(75) Inventor: Masaru Shibata, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/372,076

(22) Filed: Mar. 10, 2006

(30) Foreign Application Priority Data
Mar. 22, 2005 (JP) 2005-082429

(51) Int. Cl. H04N 5/91

(52) U.S. Cl. 386/83

(57) ABSTRACT

The invention provides a recording and playing apparatus capable of recording data via timer recording, having a simplified power control setting operation at the end time of timer recording, thereby enabling to provide an apparatus having superior power-saving feature and improved operability. When the user manipulates the recording and playing apparatus during timer recording operation, the manipulation is recorded, and at the end of timer recording, the power is automatically maintained on, or power off process is not performed, if manipulation is performed during timer recording operation. If no manipulation is performed, a screen for accepting instructions from the user to maintain the power on state is displayed, and the power is turned off if there is no instruction received within a given period of time. Thus, the manipulation for setting the power control of the apparatus at the end time of the timer recording operation is simplified.

The present application is based on and claims priority of Japanese patent application No. 2005-082429 filed on Mar. 22, 2005, the entire contents of which are hereby incorporated by reference.

### BACKGROUND OF THE INVENTION

1. Field of the Invention

The present invention relates to a recording and playing apparatus capable of performing a recording process based on so-called timer recording, and more specifically, relates to a recording and playing apparatus with a special consideration on the control of power of the apparatus at the end of the timer recording.

2. Description of the Related Art

In a recording and playing apparatus capable of recording contents such as broadcast programs on a recording medium, a “timer recording” is used widely in which the selection of the recording start time, the recording end time, the input source such as the channel and so on are set and stored in advance so that the recording process is performed automatically. The timer recording function is a function assuming that the user is absent during the recording process, so generally the power of the apparatus is turned off after the timer recording process has ended.

However, even while utilizing the timer recording function, the user may be present at the time the timer recording process is ended, and he/she may wish to use the apparatus continuously after the timer recording process has ended. In this case, the user may be bothered if the power of the apparatus is turned off automatically after the timer recording process has ended. Regarding the prior art problems mentioned above, Japanese Patent Application Laid-Open Publication No. 2-305188 (patent document 1) discloses an art related to providing a notice to the user at the end of the timer recording process, Japanese Patent Application Laid-Open Publication Nos. 2002-152645 (patent document 2) and 2003-110984 (patent document 3) disclose arts related to the power control of the apparatus at the end of the timer recording process, and Japanese Patent Application Laid-Open Publication No. 61-285879 (patent document 4) discloses an art related to the power control of the apparatus during the timer recording process.

Patent document 2 discloses an art in which the user is asked to determine whether or not to maintain the power of the apparatus on at the end of the timer recording process, and if the user does not respond, the power of the apparatus is turned off so as to cut down power consumption. According to the disclosure, the user is asked directly whether he/she wishes to use the apparatus continuously at the end of the timer recording process, so that the will of the user is closely reflected on the operation, but in cases where the user is not in the room at the end of the timer recording process or where the user did not see the instruction screen at the end of the timer recording process, the power of the apparatus is turned off despite the user's will to use the apparatus continuously. It is possible to elongate the time for displaying the instruction screen at the end of the timer recording process to overcome this problem, but in that case, the user may be annoyed by the display, and the power-saving effect is deteriorated since the power of the apparatus is maintained on for a long time.

Patent document 3 discloses an art of maintaining the power of the apparatus on at the end of the timer recording process if the apparatus is operating a playing process or the like. However, whether or not the apparatus is performing some operation at the end of the timer recording process is not necessarily linked with the user's will to use the apparatus, so in some cases the operation conditions of the apparatus must be changed. However, according to the disclosed art, a menu screen is displayed in order to change the settings, according to which the manipulation of the settings becomes complex.

### SUMMARY OF THE INVENTION

In view of the prior art problems mentioned above, the present invention aims at providing a recording and playing apparatus capable of performing a recording process via timer recording, wherein the manipulation of setting of the power control of the apparatus at the end of the timer recording is simplified so as to provide an apparatus having superior power-saving performance and improved operability.

A first aspect of the present invention relates to a recording and playing apparatus capable of recording contents to a recording medium via a timer recording operation in which a recording start time, a recording end time and an input source of video signals to be recorded is set and stored in advance, comprising a power supply unit for supplying power to each unit of the recording and playing apparatus, a power control unit for controlling the power supply from the power supply unit to each unit of the apparatus, a control unit for controlling the entirety of the apparatus, a timer unit having a clock function, a manipulation unit, and a memory unit, wherein when the power control unit is set to stop the power supply from the power supply unit at the end of the timer recording operation so as to turn the power of the apparatus to an off state at the end of the timer recording operation, if an input from a user via the manipulation unit is received during the timer recording operation, the process of stopping power supply from the power supply unit via the power control unit at the end of the timer recording operation is not performed so as to maintain the power of the apparatus at an on state after the timer recording operation has ended.

According to the above arrangement, when the user manipulates the manipulation unit by pressing the play button or the like during the timer recording operation in the state where the power of the apparatus is set to be turned off at the end of the timer recording operation, the power of the apparatus is automatically maintained at an on state even after the timer recording operation has ended.

A second aspect of the present invention relates to the recording and playing apparatus according to aspect 1, wherein when there is no input from the user via the manipulation unit during the timer recording operation, a screen is displayed at the end of the timer recording operation on either a display unit included in the recording and playing apparatus or a display device connected to the recording and playing apparatus to receive an instruction to maintain the power of the apparatus at an on state, and if an instruction from a user is received via manipulation of the manipulation unit within a given period of time, the power of the apparatus is maintained at an on state, and if no instruction from the user is received within the given period of time, the power of the apparatus is turned to an off state.

According to the above arrangement, when the user manipulates the manipulation unit by pressing the play button or the like during the timer recording operation in the state where the power of the apparatus is set to be turned off at the end of the timer recording operation, the power of the apparatus is automatically maintained at an on state even after the timer recording operation has ended. On the other hand, if the user does not manipulate the manipulation unit during the timer recording operation, a screen is displayed at the end of the timer recording operation asking for an instruction to maintain the power of the apparatus at an on state, and if an instruction from a user is not received within the given period of time, the power of the apparatus is turned to an off state, but if the user responds, the power of the apparatus is maintained at an on state.

A third aspect of the present invention relates to the recording and playing apparatus according to aspects 1 or 2, wherein if the input from a user via the manipulation unit during the timer recording operation is the input of a power key, the setting whether to turn the power of the apparatus to an off state or to maintain the power at an on state at the end of the timer recording operation is changed according to the input of the power key, and information regarding the changed setting is displayed on either the display unit included in the recording and playing apparatus or the display device connected to the recording and playing apparatus.

According to the above arrangement, when the power key is pressed during the timer recording operation in the state where the power of the apparatus is set to be turned off at the end of the timer recording operation, the setting of the apparatus is changed so as to maintain the power of the apparatus on at the end of the timer recording operation, and a notice informing that there had been a change of setting is displayed on the screen. In this state, if the power key is pressed again, the setting is changed to turn the power of the apparatus off at the end of the timer recording operation, and a notice informing that there had been a change of setting is displayed on the screen.

A fourth aspect of the present invention relates to the recording and playing apparatus according to any one of aspects 1 through 3, wherein when there is an input from a user via the manipulation unit during the timer recording operation, a selection screen enabling selection between maintaining the power to an on state or turning the power to an off state of the recording and playing device at the time the timer recording operation is ended is displayed on either the display unit included in the recording and playing apparatus or the display device connected to the recording and playing apparatus, and the power supply control unit is enabled to control the power supply at the time the timer recording operation is ended according to the selection performed by the user.

According to the above arrangement, when the user manipulates the manipulation unit by pressing the play button or the like during the timer recording operation, a selection screen enabling selection between maintaining the power to an on state or turning the power to an off state of the recording and playing device at the time the timer recording operation is ended is displayed when the user presses the button, and according to the user's selection, the power is maintained on or turned off at the end of the timer recording operation.

A fifth aspect of the present invention relates to a recording and playing apparatus capable of recording contents to a recording medium via a timer recording operation in which a recording start time, a recording end time and an input source of video signals to be recorded is set and stored in advance, comprising a power supply unit for supplying power to each unit of the recording and playing apparatus, a power control unit for controlling the power supply from the power supply unit to each unit of the apparatus, a control unit for controlling the entirety of the apparatus, a timer unit having a clock function, a manipulation unit, and a memory unit, wherein when the apparatus is at a playing state at the end of the timer recording operation, the power of the apparatus is maintained at an on state by maintaining the power supply state from the power supply unit after the timer recording operation has ended, but when the apparatus is not at a playing state at the end of the timer recording operation, a screen is displayed on either a display unit included in the recording and playing apparatus or a display device connected to the recording and playing apparatus to receive an instruction to maintain the power of the apparatus at an on state, and if an instruction from a user is received via manipulation of the manipulation unit within a given period of time, the power of the apparatus is maintained at an on state, and if no instruction from the user is received within the given period of time, the power of the apparatus is turned to an off state.

According to the above arrangement, if the apparatus is at a playing state at the end of the timer recording operation, the power of the apparatus is maintained on. On the other hand, if the apparatus is not at a playing state at the end of the timer recording operation, a screen is displayed to ask for an instruction to maintain the power of the apparatus on, and if no response is received from the user within a given period of time, the power of the apparatus is turned off, while if a response is received from the user, the power of the apparatus is maintained on.

A sixth aspect of the invention relates to a recording and playing apparatus capable of recording contents to a recording medium via a timer recording operation in which a recording start time, a recording end time and an input source of video signals to be recorded is set and stored in advance, comprising a power supply unit for supplying power to each unit of the recording and playing apparatus, a power control unit for controlling the power supply from the power supply unit to each unit of the apparatus, a control unit for controlling the entirety of the apparatus, a timer unit having a clock function, a manipulation unit, and a memory unit, wherein when a power key is entered during the timer recording operation, the setting on whether or not to turn the power to an off state or to maintain the power at an on state at the end of the timer recording operation is changed according to the input of the power key, and at the same time, the information regarding the changed setting is displayed on either a display unit included in the recording and playing apparatus or a display device connected to the recording and playing apparatus, and when the apparatus is at a playing state at the end of the timer recording operation, the power of the apparatus is maintained at an on state by maintaining the power supply state from the power supply unit after the timer recording operation has ended regardless of the power setting at the end of the timer recording operation, but when the apparatus is not at a playing state at the end of the timer recording operation, the power control unit controls the power supply according to the power setting at the end of the timer recording operation.

According to the above arrangement, if the power key is entered during the timer recording operation in which the power of the apparatus is set to be turned off at the end of the timer recording process, the setting is changed to maintain the power of the apparatus on at the end of the timer recording process, and a notice informing that there had been a change of setting is displayed on the screen. If the power key is further pressed in this state, the setting is changed to turn the power of the apparatus off at the end of the timer recording process, and a notice informing that there had been a change of setting is displayed on the screen. When the apparatus is not at a playing state when the timer recording operation has ended, the power control is performed according to the setting, but on the other hand, when the apparatus is at a playing state when the timer recording operation has ended, the power of the apparatus is maintained on regardless of the setting.

### BRIEF DESCRIPTION OF THE DRAWINGS

FIG. 1 is a block diagram showing the outline of a portion of a DVD recorder/player built-in LCD relevant to the present invention;

FIG. 2 is a perspective view of the DVD built-in LCD;

FIG. 3 is a flowchart showing the outline of the operation of the portion of the DVD built-in LCD relevant to the present invention;

FIG. 4 is a view showing one example of a display screen (OSD display);

FIG. 5 is a flowchart showing the outline of an operation process regarding the power control at the end time of timer recording operation of the DVD built-in LCD according to embodiment 2;

FIG. 6 is a view showing one example of a display screen (OSD display);

FIG. 7 is a flowchart showing a process in which the functions of embodiment 1 (FIG. 3) and embodiment 2 (FIG. 5) are combined;

FIG. 8 is a flowchart showing a process in which the functions of embodiment 1 (FIG. 3) and embodiment 2 (FIG. 5) are combined;

FIG. 9 is a flowchart showing the outline of an operation process regarding the power control at the end time of timer recording operation of the DVD built-in LCD according to embodiment 3;

FIG. 10 is a view showing one example of a display screen (OSD display);

FIG. 11 is a flowchart showing the outline of the operation process regarding the power control at the end of timer recording operation according to another example;

FIG. 12 is a flowchart showing the outline of the operation process regarding the power control at the end of timer recording operation according to another example; and

FIG. 13 is a flowchart showing a process in which the functions of embodiment 2 (FIG. 5) and embodiment 3 (FIG. 9) are combined.

### DETAILED DESCRIPTION OF THE PREFERRED EMBODIMENTS

Now, the preferred embodiments of the present invention will be described in detail with reference to the drawings. Needless to say, the following embodiments are mere examples of the applications of the present invention, and do not limit the scope of the present invention in any way.

### Embodiment 1

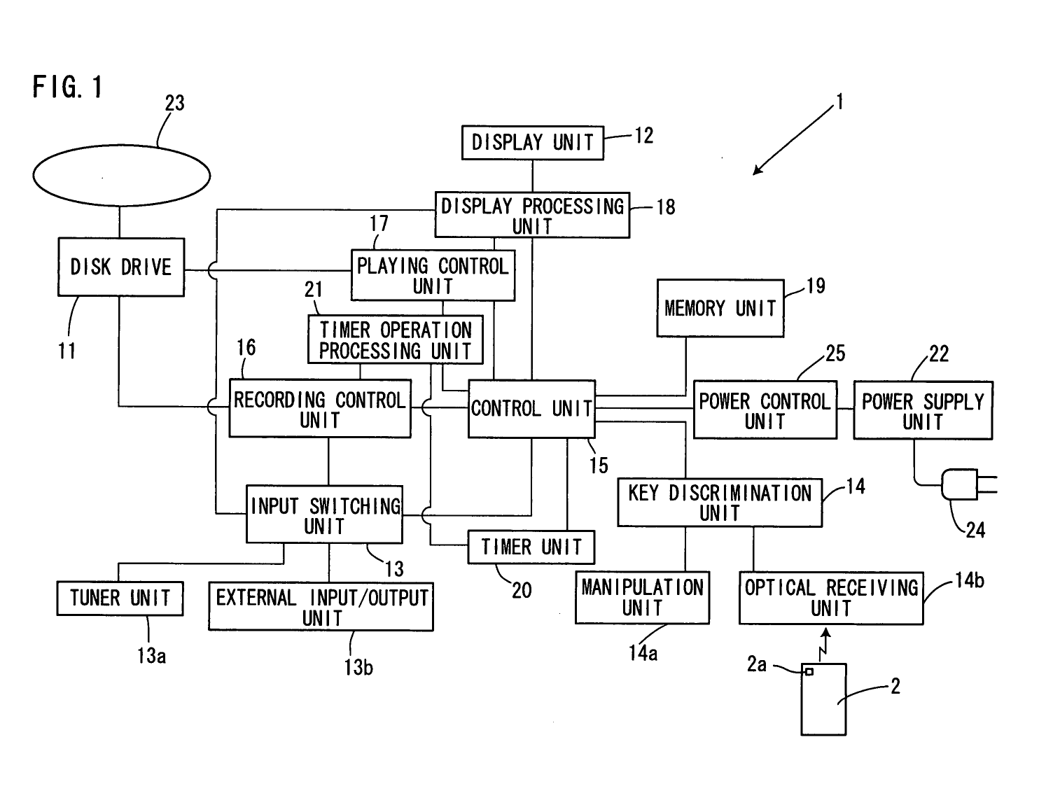

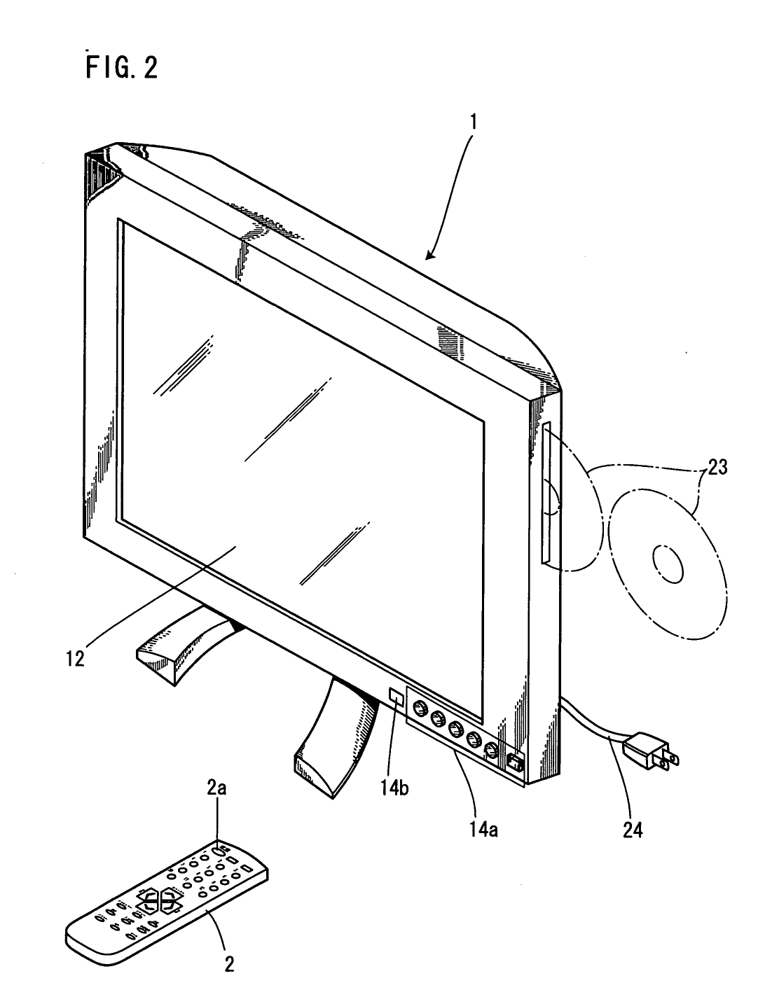

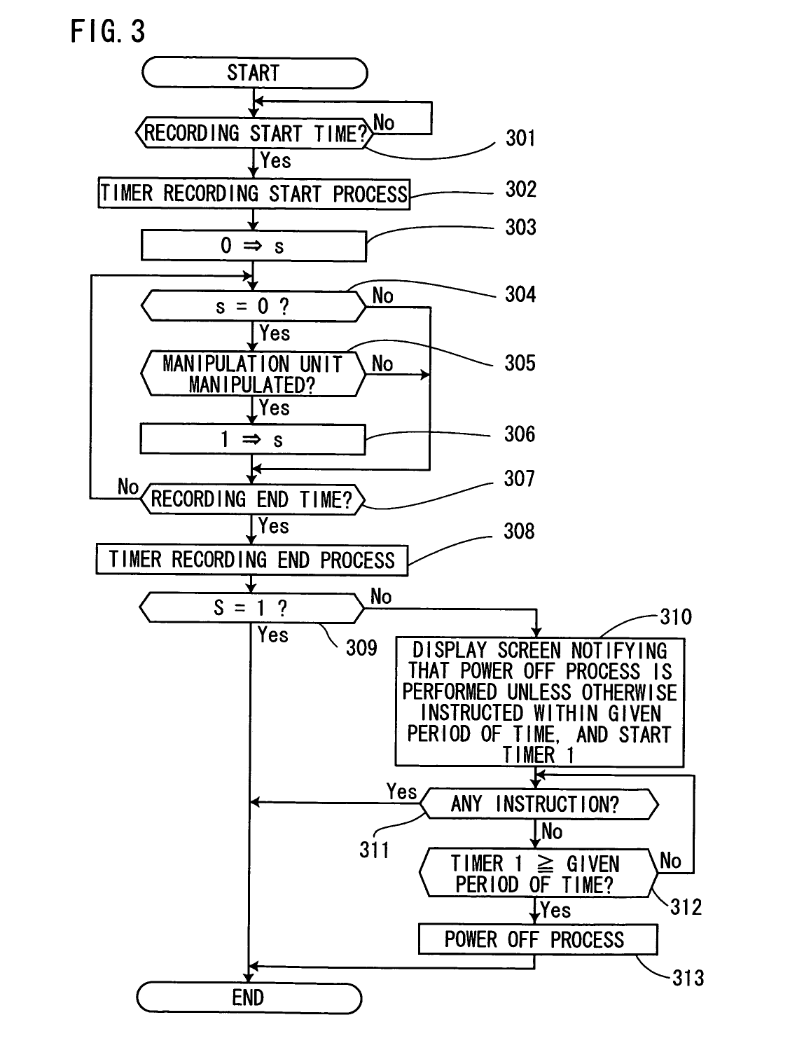

FIG. 1 is a block diagram illustrating the outline of a portion of a DVD recording and playing apparatus built-in LCD according to the present embodiment related to the present invention, FIG. 2 is a perspective view of the DVD recording and playing apparatus built-in LCD according to the same, and FIG. 3 is a flowchart showing the outline of the operation related to the present invention.

As shown in FIG. 1, the DVD recording and playing apparatus built-in LCD (hereinafter simply referred to as DVD built-in LCD) 1 according to the present embodiment comprises a disk drive 11 for writing signals to or reading signals from a DVD 23 which is a recording medium, a display unit 12, an input switching unit 13 for switching signals from a tuner unit 13a or an external input/output unit 13b and outputting the same, a key discrimination unit 14 for discriminating and outputting signals from a manipulation unit 14a or an optical receiving unit 14b, a control unit 15 for controlling the entirety of the apparatus, and so on. The DVD built-in LCD 1 further comprises a recording control unit 16 equipped with an encoder for converting the video audio signals inputted via the input switching unit 13 to signals corresponding to the MPEG standard and a function for generating recording data corresponding to the standard DVD-VR format, a playing control unit 17 having a decoder and the like for expanding the data entered from the disk drive 11, a display processing unit 18 performing a process to display the video signals entered via the input switching unit 13 or the playing control unit 17 and the like on the display unit 12, a memory unit 19, a timer unit 20 having a clock function, a timer operation processing unit 21 performing the process of a timer recording operation, a power supply unit 22 for supplying power to the units of the apparatus, a power supply control unit 25 for controlling the power supply from the power supply unit 22 to each unit of the apparatus, and so on.

Next, the outline of the operation process regarding the power supply control at the end of a timer recording process according to the DVD built-in LCD 1 of the present embodiment will be described with reference to FIG. 3. The setting of the timer recording is performed by the user manipulating a remote controller 2 or a manipulation unit 14a to select the date and time of recording start time, the date and time of recording end time and the input source of the video signal to be recorded, and by having the contents of the setting stored in the memory unit 19. The instructions from the user and the action of the user for acquiring various information via the manipulation of the remote controller 2 or the manipulation unit 14a based on the information displayed on the screen of a display of the display unit 12 or the remote controller 2 are discriminated and recognized by the key discrimination unit 14 and the control unit 15. The same applies for the various instructions and operations for acquiring information in the following description.

In step 301, it is determined whether or not the recording start time has been reached by comparing the recording start time stored in the memory unit 19 and the current time acquired from the timer unit 20 in the control unit 15, and when it is determined that the recording start time has been reached, the power supply control unit 25 performs a power on process when the power of the apparatus is turned off, the timer recording process is started by allowing the timer operation processing unit 21 to start the process (step 302), and in step 303, 0 is assigned to variable s, which is stored in the memory unit 19. In the following step 304, it is determined whether the variable s is 0 or not, and if it is 0, the process advances to step 305 where the key discrimination unit 14 and the control unit 15 determine whether the user has manipulated the remote controller 2 or the manipulation unit 14a, and 1 is assigned to s when there had been a manipulation (step 306), but if not, the process advances to step 307. If there had been any manipulation by the user, the process operation corresponding to the instruction will be performed at this time, but the detailed description of which is omitted in the present description since the processes regarding the present invention are described mainly. If step 304 is negative, the process advances to step 307. In step 307, it is determined whether the recording end time has been reached or not, and when the recording end time has not been reached, the process advances to step 304 and the processes of steps 304 through 307 are repeated. When the recording end time had been reached, the process advances to step 308 where the timer recording end process, such as the output of instruction from the recording operation processing unit 21 to the recording control unit 16 to stop the recording operation, is performed, and it is determined whether or not s equals 1 (step 309).

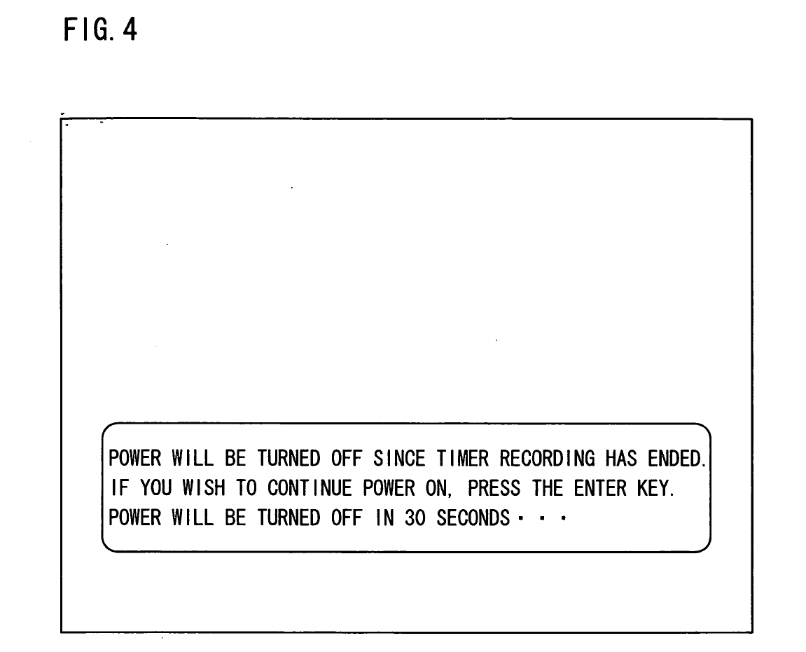

If the determination in step 309 is negative, that is, if there is no manipulation by the user during the timer recording operation, the process advances to step 310 to display a screen illustrated in FIG. 4 (which according to the present embodiment displays a countdown of the remaining time for accepting manipulation) on the display unit 12 via the control unit 15 and the display processing unit 18 via OSD display, and starts timer 1 of the timer unit 20. In step 311, whether a corresponding instruction from the user, which according to the present embodiment is the input of an ENTER key on the remote controller 2, has been entered or not is determined, and if there is no instruction, the process advances to step 312, where it is determined whether timer 1 has counted a predetermined period of time or not, which according to the present embodiment is 30 seconds. If that period of time has not passed, the process returns to step 311, and it that time had passed, in other words, if there were no instruction from the user during the predetermined period of time, the procedure advances to step 313 where the control unit 15 and the power supply control unit 25 perform a power off process, and the process is ended. On the other hand, if the determination in step 309 is positive, that is, if there was a manipulation by the user during the timer recording operation, and if the determination in step 311 is also positive, that is, if there was an instruction from the user during the predetermined period of time, the power supply control process at the end of the timer recording operation is terminated without performing the power off process. In other words, the power of the apparatus stays on even after the timer recording operation has ended. The power off state of the apparatus is the state in which the apparatus is at a stand-by mode wherein the power supply to unnecessary units of the apparatus are stopped and power supply to only the relevant units such as the microcomputer is maintained, or at a state in which the main power of the apparatus is turned off, which may include the case in which power supply to only the microcomputer is maintained.

As described, according to the DVD built-in LCD 1 of the present embodiment, when the user performs manipulation, such as pressing of the play button, during timer recording operation, the power of the apparatus is maintained on automatically even after the timer recording operation has ended. In other words, the manipulation of the apparatus by the user during the timer recording operation is assumed as the will of the user to use the apparatus, and accordingly, the power of the apparatus is automatically maintained on. Thus, the user can use the apparatus continuously without any manipulation to maintain the power on state, by which the user-friendliness of the apparatus is improved. Moreover, if the user does not manipulate the apparatus during timer recording operation, a screen requesting an instruction to maintain the power-on state of the apparatus is displayed at the end of the timer recording operation, and if there is no response from the user within a predetermined period of time, the power of the apparatus is turned off, while on the other hand, if there is a response from the user, the power of the apparatus is maintained on. According to this operation, the apparatus operates based more on the will of the user, and the power consumption of the apparatus is cut down since the time that the power of the apparatus is maintained on uselessly is reduced.

According to the present embodiment, whether or not the user manipulates the apparatus throughout the whole timer recording operation is determined, but it is also possible to determine whether or not the user manipulates the apparatus during a given period of time, such as by performing steps 304 through 306 only during a given period of time prior to ending timer recording, to thereby maintain the power of the apparatus on only when the user manipulates the apparatus at a timing close to the end of the recording. Moreover, it is possible to provide an OSD display saying that “the power is maintained on after the timer recording is ended” at the time the user manipulates the apparatus. In addition, according to the present embodiment, whether or not the user manipulates the apparatus during the timer recording operation is stored in the memory by a variable s, and the determination is performed at the time the timer recording is ended. However, in case the power of the apparatus is set to be turned off when the timer recording operation is ended, it is possible to change the setting at the time the user manipulates the apparatus during the timer recording operation, so as to maintain the power of the apparatus on after the timer recording operation has ended.

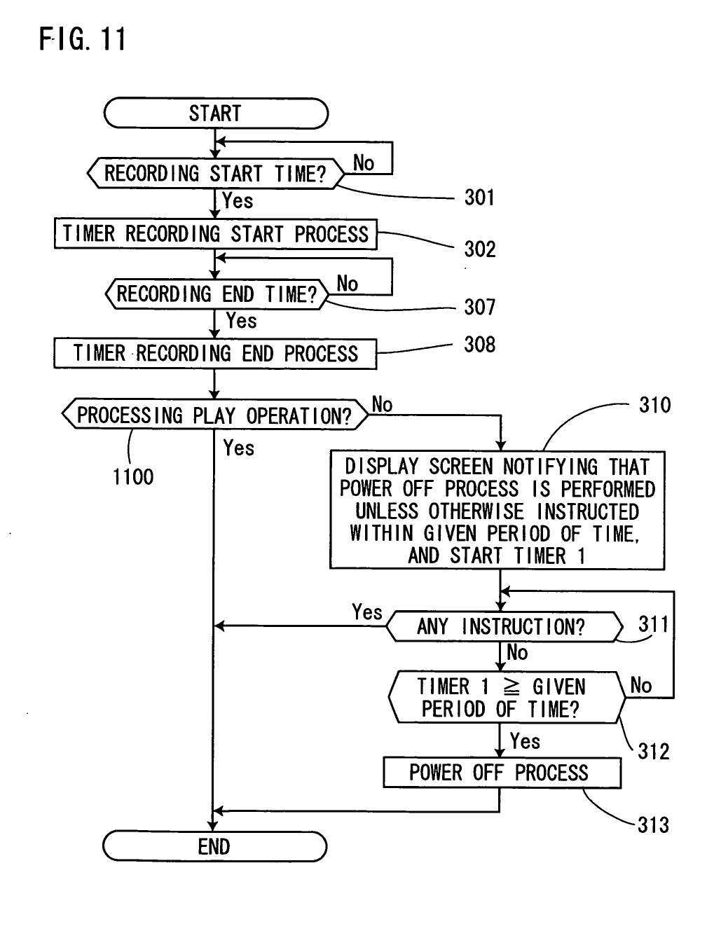

FIG. 11 illustrates another example of the process regarding the control of power at the end of the timer recording operation. The operations equivalent to those of FIG. 3 are denoted with the same reference numbers. According to the process illustrated in FIG. 11, whether or not the user manipulates the apparatus during timer recording operation is not determined, but instead, whether or not the apparatus is at a playing process is determined (step 1100). The determination is performed by the control unit 15 and the play control unit 17, and when it is determined that the apparatus is not at a playing state, the processes of steps 310 through 313 are performed, but when the apparatus is at a playing state, the process is ended without performing the power off process. Thus, the power of the apparatus is maintained on if the apparatus enters a playing process when the timer recording process is ended, and if the apparatus does not enter a playing process, a screen asking for instruction to maintain the power on state of the apparatus is displayed. If the user does not respond within a given period of time, the power of the apparatus is turned off, and if the user responds, the power of the apparatus is maintained on.

### Embodiment 2

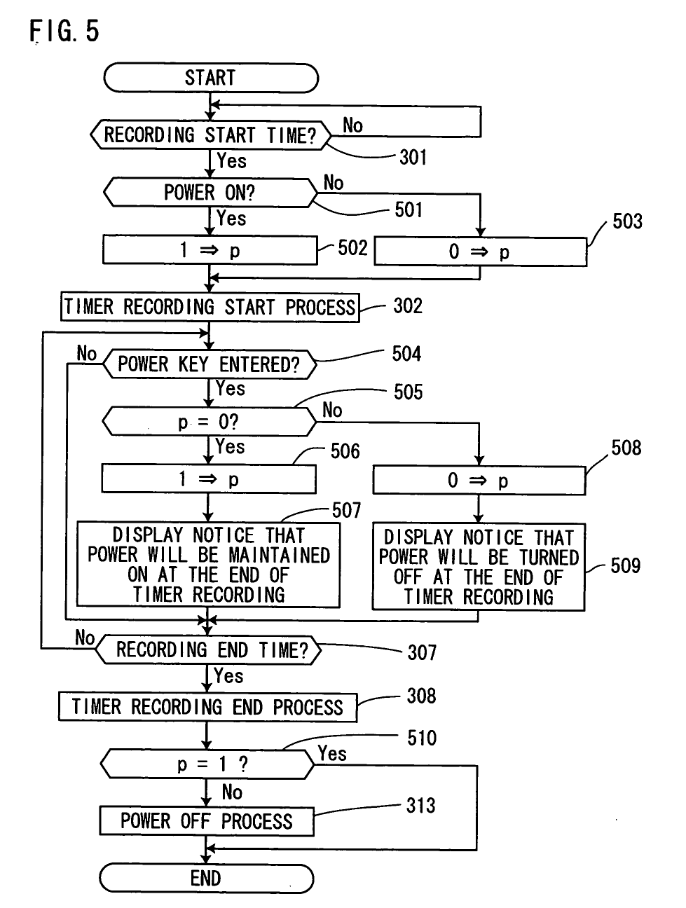

FIG. 5 is a flowchart showing the outline of the operation process regarding the power control performed at the end of the timer recording operation of the DVD built-in LCD according to the present embodiment. Further, since the arrangement of the DVD built-in LCD according to the embodiment is similar to that of embodiment 1, the detailed description thereof is omitted, and FIG. 1 is referred to if necessary for description.

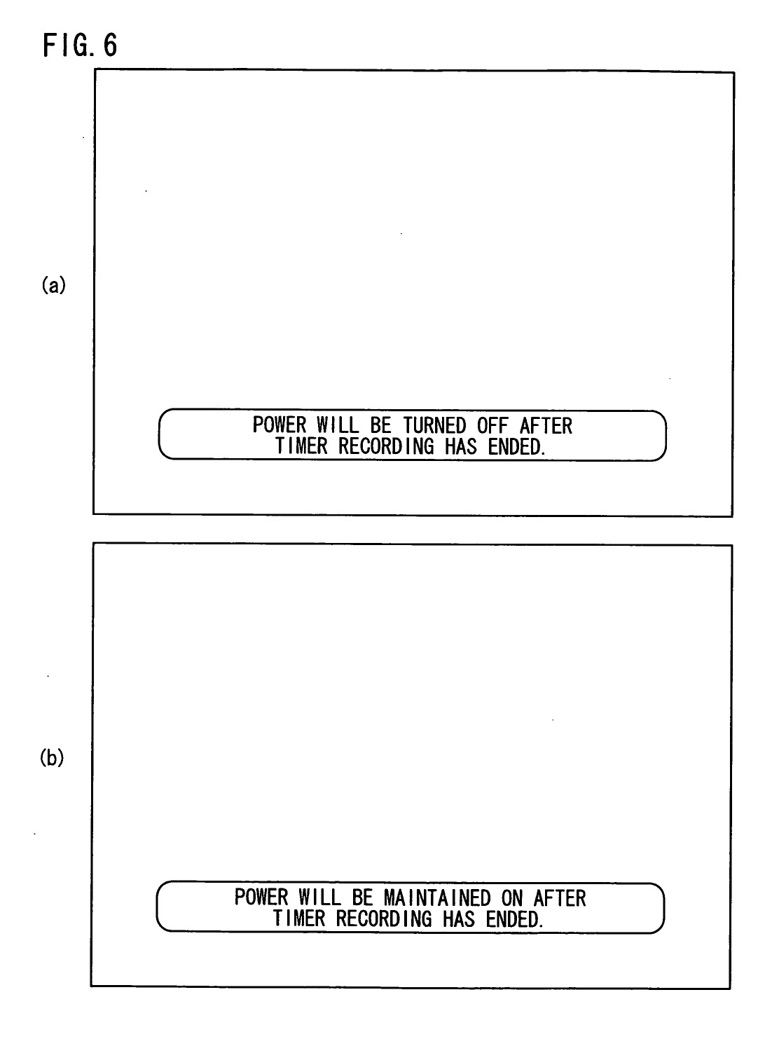

With reference to FIG. 5, the outline of the operation process regarding the power control performed at the end of the timer recording operation according to the DVD built-in LCD of the present embodiment will be described with reference to FIG. 5. Here, the operations equivalent to those of embodiment 1 (FIG. 3) are denoted with the same reference numbers, and the descriptions thereof are omitted. In step 501, whether the power state of the apparatus directly prior to starting the timer recording operation is on or not is determined by the control unit 15 and the power control unit 25, and if it is on, 1 is assigned to variable p (step 502), and if it is off, 0 is assigned to variable p (step 503), the result of which is stored in the memory unit 19. After the timer recording start process (step 302), in step 504, whether or not the power key 2a, which is a power switch on the remote control apparatus 2, is pressed or not is determined. If not, the procedure advances to step 307, but if the power key 2a is pressed, whether variable p is 0 or not is determined in step 505. If p equals 0, then 1 is assigned to p (step 506) and a screen shown in FIG. 6(b) is displayed via OSD display (step 507), and on the other hand, if p equals 1, then 0 is assigned to p (step 508) and a screen shown in FIG. 6(a) is displayed via OSD display (step 509), before the procedure advances to step 307. If the determination in step 307 is negative, in other words, if the recording end time has not come, the procedure returns to step 504 and the process is repeated.

When the recording end time has come, the procedure advances via step 308 to step 510, where it is determined whether p equals 1 or not, wherein if p equals 0, a power off process (step 313) is carried out, and if p equals 1, the power control process at the end of the timer recording process is terminated without performing the power off process, in other words, the power of the apparatus is maintained on after the timer recording process has ended.

As described, according to the power control process at the end of the timer recording process of the present embodiment, the setting of the power control of the apparatus at the end of the timer recording operation is turned from on to off or from off to on each time the power key is pressed during the timer recording operation, and the change of setting is displayed via OSD display, so that the power control setting of the apparatus at the end of the timer recording operation can be changed easily by a simple manipulation, and the operability of the apparatus is improved. Moreover, since the current setting is displayed via OSD display, the present operation can be used to confirm the current setting, such as by pressing the power key 2a when the current setting status is unknown to confirm the setting status of the apparatus, according to which the user-friendliness of the apparatus is improved. Further, since the power control setting of the apparatus can be changed at any optional timing during timer recording operation, it becomes possible to prevent the inconvenience of not being able to perform the desired power control operation, such as when the user is out of the room at that time and missing the indication to change the setting, that may occur if the power control setting is enabled to be changed only within a predetermined period of time at the end of the timer recording operation.

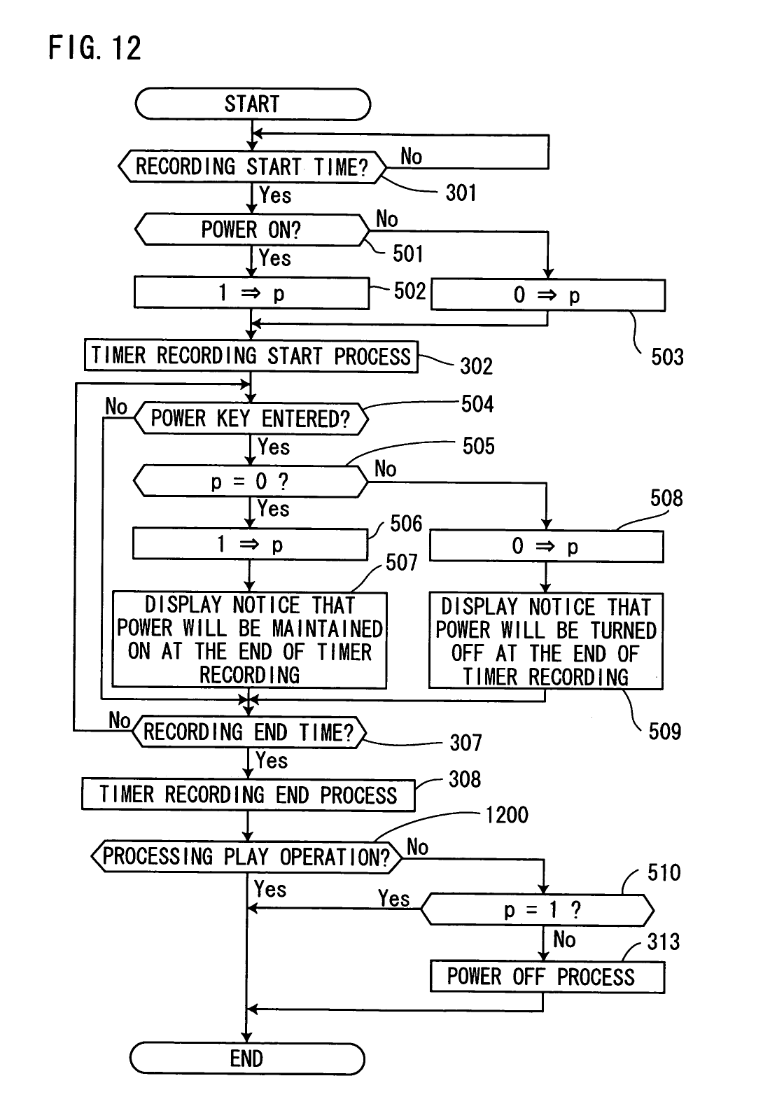

FIG. 12 illustrates another example of the process regarding the power control process at the end of the timer recording operation. The operations equivalent to those of FIG. 5 are denoted with the same reference numbers. According to the process shown in the drawing, whether the apparatus is at a playing state or not is determined when the timer recording process is ended (step 1200). When it is determined that the apparatus is not at a playing state, the processes of step 510 and step 313 are performed, and when it is determined that it is at a playing state, the process is ended without performing the power off process. Thus, if the apparatus is at a playing state when the timer recording process is ended, the power of the apparatus is maintained on, and if not, the power control process is performed according to the state of variable p, which is determined by the power state of the apparatus at the time the timer recording operation is started and the number of inputs of the power key during the timer recording operation.

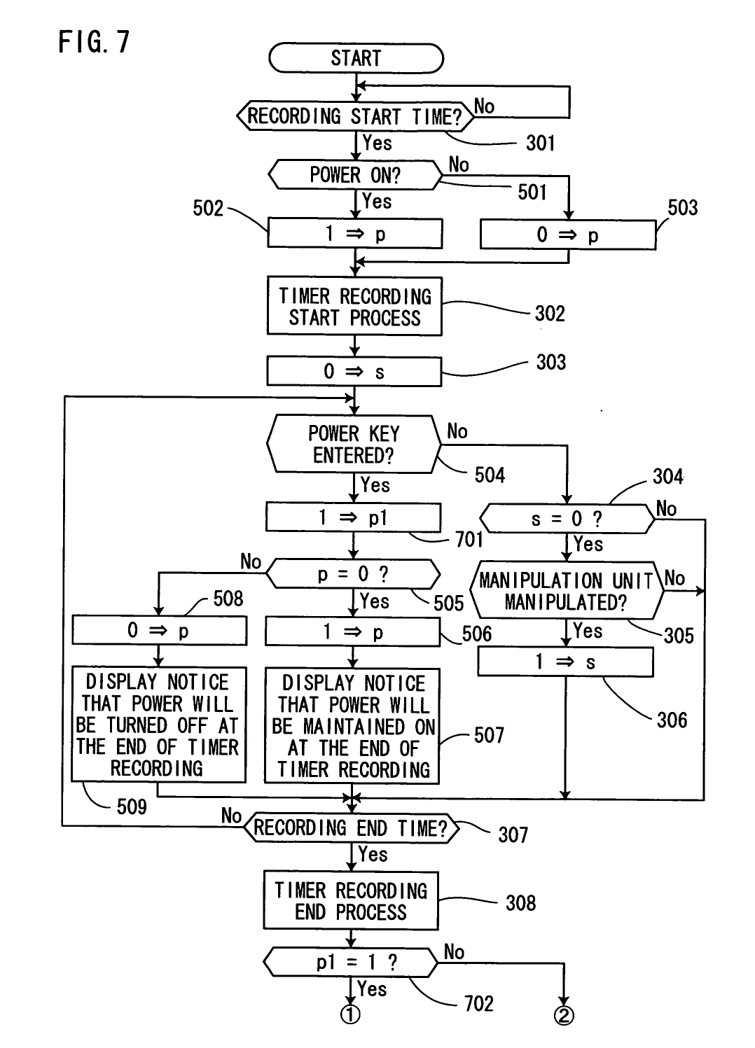

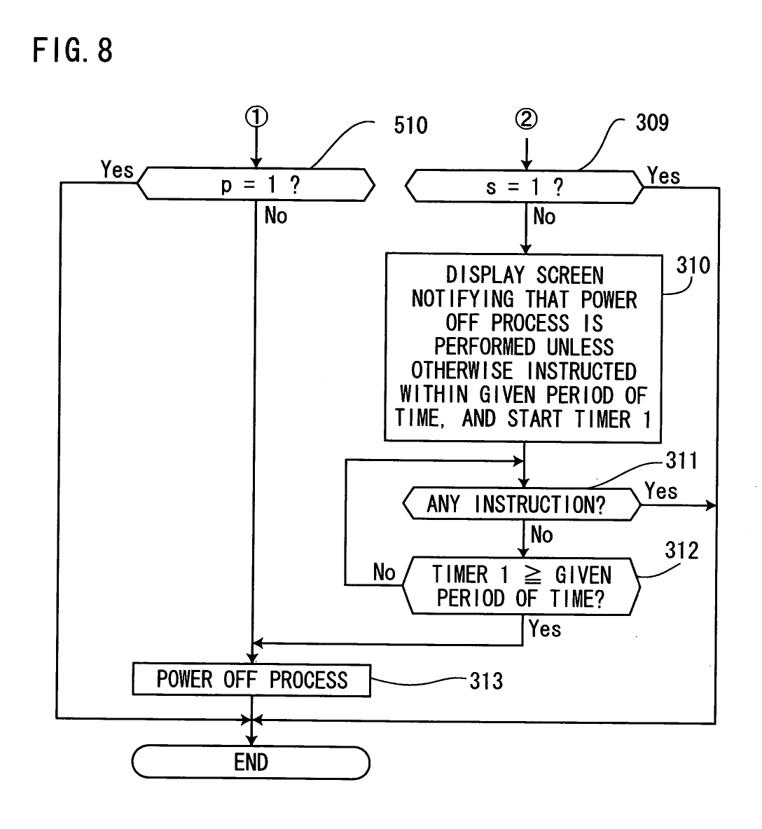

Moreover, FIGS. 7 and 8 illustrate a process that takes in both the functions of embodiment 1(FIG. 3) and embodiment 2(FIG. 5). The same reference numbers are used for the equivalent processes as embodiments 1(FIG. 3) and 2(FIG. 5), and the detailed descriptions thereof are omitted. In step 701, by substituting 1 in variable p1, it is possible to determine whether the power key was entered during timer recording operation or not, and the actual determination is performed in step 702 at the end of the timer recording process. If the power key is entered during timer recording operation, power control is performed based on the “setting of the power control of the apparatus at the end of the timer recording process” performed by entering the power key (step 510 and step 313), and if the power key was not entered, power control is performed based on whether other operations were performed during timer recording operation (steps 309 through 313) Thus, the change of settings performed by the entry of the power key during the timer recording operation is prioritized in the power control of the apparatus at the end of the timer recording process.

### Embodiment 3

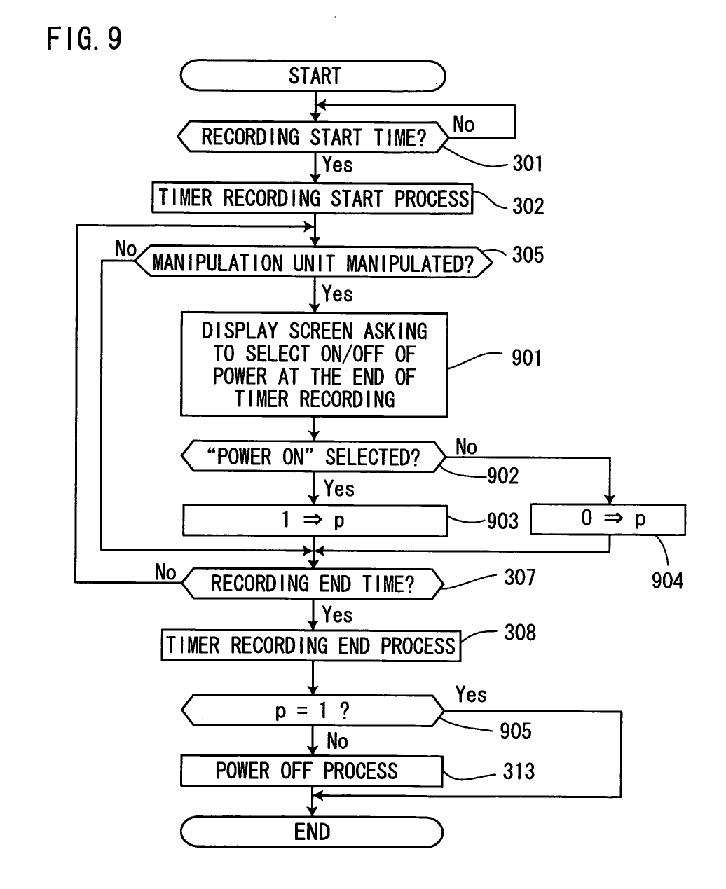

FIG. 9 is a flowchart showing the outline of the operation regarding the power control process at the end of the timer recording process of the DVD built-in LCD according to the present embodiment. Since the arrangement of the DVD built-in LCD according to the present embodiment is similar to that of embodiment 1, the detailed descriptions thereof are omitted, and FIG. 1 is referred to if necessary for description.

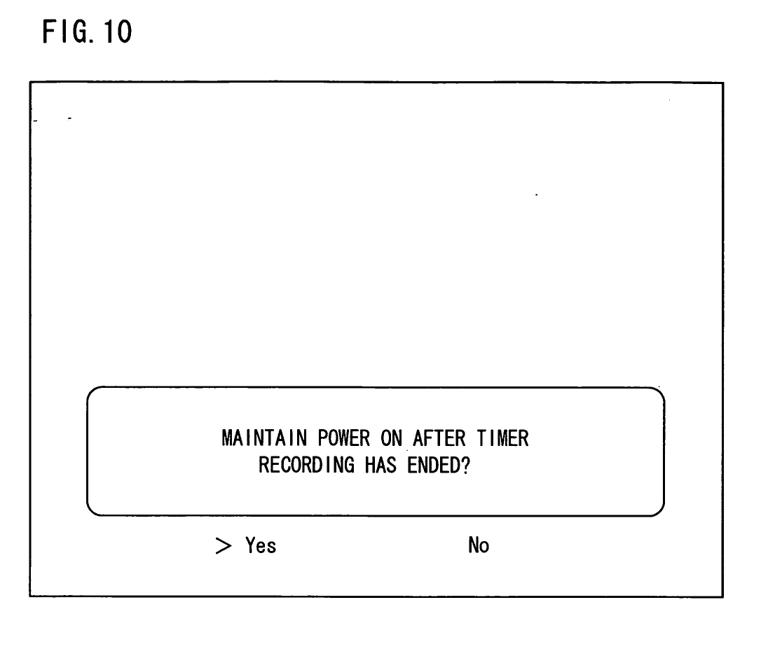

The outline of the operation regarding the power control process at the end of the timer recording process according to the DVD built-in LCD of the present embodiment is described with reference to FIG. 9. The operations equivalent to those of embodiment 1(FIG. 3) are denoted with the same reference numbers, and detailed descriptions thereof are omitted. In the determination process of step 305, if the user manipulates the remote controller 2 or the manipulation unit 14a, the procedure advances to step 901, where the screen shown in FIG. 10 is displayed via OSD display through which the user is asked to select whether the power should be turned off or maintained on at the end of the timer recording operation. When “power on” is selected, the procedure advances to step 903 (step 902), where 1 is assigned top and stored in the memory unit, and when “power off” is selected, the procedure advances to step 904 (step 902), where 0 is assigned to p and stored in the memory unit. When the recording end time has come, the procedure advances via step 308 to step 905, where p equals 1 or not is determined. If p equals 0, the power off process (step 313) is performed, and if p equals 1, the power control process at the end of timer recording operation is ended without performing the power off process, in other words, the power of the apparatus is maintained on after the timer recording process has ended. According to the present embodiment, the initial value of variable p is 0, which means that the power of the apparatus is turned off when the timer recording process is ended. It is also possible to achieve the value of p similarly as the process of FIG. 5 by performing steps 501 through 503 of FIG. 5 between steps 301 and 302.

As described, according to the power control process of the present embodiment at the end of the timer recording operation, if the user manipulates the apparatus during the timer recording operation, a screen requesting the user to set the power control state of the apparatus at the end of the timer recording operation is displayed, and according to the setting performed by the user, the power control of the apparatus at the end of the timer recording operation is performed. In other words, since the screen for “setting the power control state of the apparatus at the end the timer recording operation” is displayed automatically every time the user manipulates the apparatus indicating the change of will of the user using the apparatus, the apparatus has superior operability compared to the case in which the change of setting is performed by displaying a separate menu screen.

According to the present embodiment, the power control setting of the apparatus at the end of timer recording operation is requested each time the user manipulates the apparatus during the timer recording operation. However, it is possible to request the change of setting only when a specific manipulation, such as a play operation, is performed, or only when the first manipulation is performed, or only when the manipulation is performed within a given period of time before the end of recording.

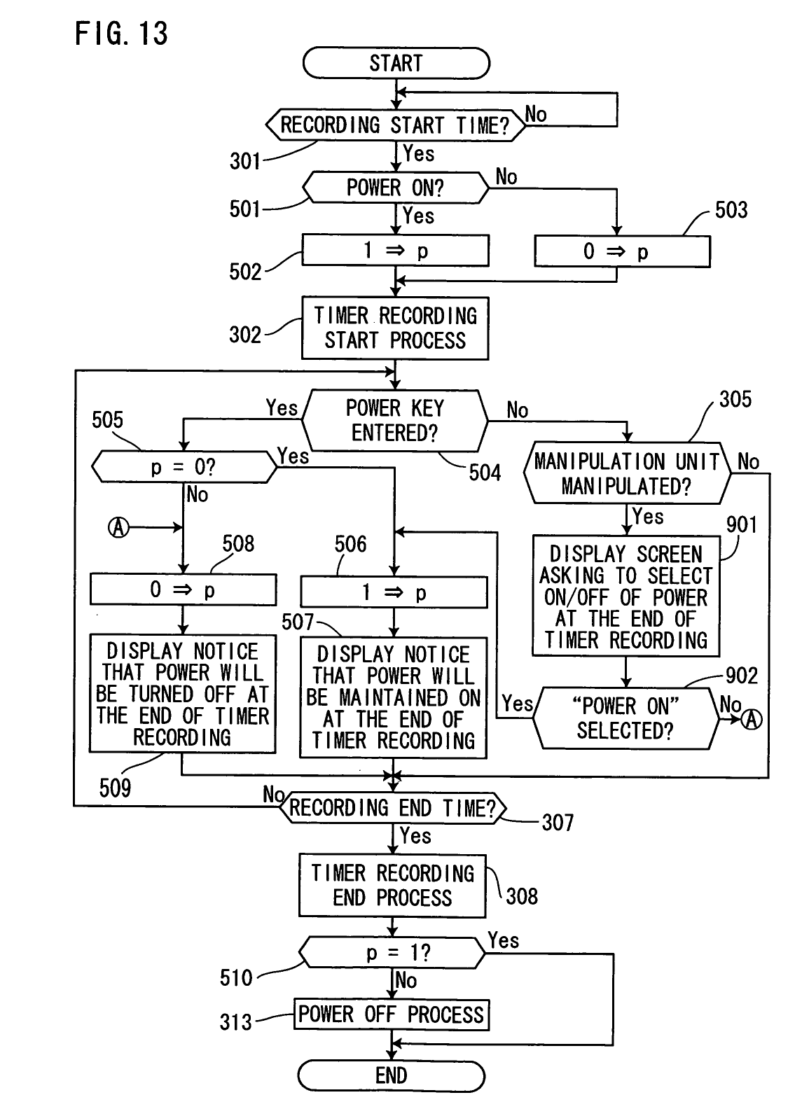

FIG. 13 illustrates a process taking in both the functions of embodiment 2(FIG. 5) and the present embodiment (FIG. 9). The same reference numbers are used for the equivalent processes as embodiments 2(FIG. 5) and the present embodiment (FIG. 9). According to the present process, when the user manipulates the apparatus during the timer recording operation, the user is asked to set the power control setting of the apparatus at the end of the timer recording operation, and when the user enters the power key during the timer recording operation, the power control setting is varied thereby.

A DVD built-in LCD is provided as the actual example of the recording and playing apparatus in the present embodiment, but the present invention is not restricted thereto. Other recording media such as optical disk media other than DVD, magnetic disk media such as HDD, magnetic tape media such as VTR, and semiconductor elements such as flash memory can be adopted as the recording media for the present invention, and the recording and playing apparatus of the present invention includes recorders and players for the above-listed recording media. As can be recognized by the description of the embodiments regarding the DVD built-in LCD 1, the recording and playing apparatus according to the present invention is not limited to apparatuses for recording and playing images on a recording media, but includes composite apparatuses in which the recording and playing apparatus is integrated with other functions. If the recording and playing apparatus refers to an apparatus that only records and plays images on a recording media, the “OSD display” process in the processes described herein refer to the process in which OSD signals are superposed with video signals to display images on the display device such as a television connected to the recording and playing apparatus or to display the same on a display unit such as a display tube included in the recording and playing apparatus.

The effects of the present invention are as follows.

The first aspect of the present invention relates to a recording and playing apparatus capable of recording contents to a recording medium via a timer recording operation in which a recording start time, a recording end time and an input source of video signals to be recorded is set and stored in advance, comprising a power supply unit for supplying power to each unit of the recording and playing apparatus, a power control unit for controlling the power supply from the power supply unit to each unit of the apparatus, a control unit for controlling the entirety of the apparatus, a timer unit having a clock function, a manipulation unit, and a memory unit, wherein when the power control unit is set to stop the power supply from the power supply unit at the end of the timer recording operation so as to turn the power of the apparatus to an off state at the end of the timer recording operation, if an input from a user via the manipulation unit is received during the timer recording operation, the process of stopping power supply from the power supply unit via the power control unit at the end of the timer recording operation is not performed so as to maintain the power of the apparatus at an on state after the timer recording operation has ended. According to the above arrangement, when the user manipulates the manipulation unit by entering the play button or the like during the timer recording operation in the state where the power of the apparatus is set to be turned off at the end of the timer recording operation, the power of the apparatus is automatically maintained at an on state even after the timer recording operation has ended. That is, it is assumed that the user has the will to use the apparatus if the user manipulates the apparatus during the timer recording operation, and accordingly, the power of the apparatus is automatically maintained at an on state so that the user can use the apparatus continuously without performing any special manipulation to maintain the power, and thus the convenience of the user is enhanced.

The second aspect of the present invention provides a recording and playing apparatus according to aspect 1, wherein when there is no input from the user via the manipulation unit during the timer recording operation, a screen is displayed at the end of the timer recording operation on either a display unit included in the recording and playing apparatus or a display device connected to the recording and playing apparatus to receive an instruction to maintain the power of the apparatus at an on state, and if an instruction from a user is received via manipulation of the manipulation unit within a given period of time, the power of the apparatus is maintained at an on state, and if no instruction from the user is received within the given period of time, the power of the apparatus is turned to an off state. According to the arrangement, when the user does not manipulate the manipulation unit during timer recording operation, a screen requesting an instruction to maintain the power of the apparatus on is displayed at the end of the timer recording operation, and when there is no response from the user within a given time, the power of the apparatus is turned off. However, if the user responds, the power of the apparatus is maintained on, according to which the operation corresponds more to the user's will to use the apparatus.

The third aspect of the present invention provides a recording and playing apparatus according to aspects 1 or 2, wherein if the input from a user via the manipulation unit during the timer recording operation is the input of a power key, the setting whether to turn the power of the apparatus to an off state or to maintain the power at an on state at the end of the timer recording operation is changed according to the input of the power key, and information regarding the changed setting is displayed on either the display unit included in the recording and playing apparatus or the display device connected to the recording and playing apparatus. According to this arrangement, the power control setting of the apparatus at the end of the timer recording operation is switched from on to off or from off to on each time the power key is entered during the timer recording operation, and a screen displaying that the setting has been changed is displayed. Thus, the power control setting of the apparatus at the end of the timer recording operation can be changed through a very simple operation, and since the status of the setting is displayed on the screen, the usability of the apparatus is improved.

The fourth aspect of the present invention provides a recording and playing apparatus according to any one of aspects 1 through 3, wherein when there is an input from a user via the manipulation unit during the timer recording operation, a selection screen enabling selection between maintaining the power at an on state or turning the power to an off state of the recording and playing device at the time the timer recording operation is ended is displayed on either the display unit included in the recording and playing apparatus or the display device connected to the recording and playing apparatus, and the power supply control unit controls the power supply at the time the timer recording operation is ended according to the selection performed by the user. According to this arrangement, a selection screen enabling selection between maintaining the power on or turning the power off at the end of the timer recording operation is displayed when the user performs manipulation during timer recording operation, and based on the selection performed by the user, the power of the apparatus is either maintained on or turned off at the end of the timer recording operation. Thus, the operation can be performed corresponding more to the users will to use the apparatus by a simple operation.

1. A recording and playing apparatus capable of recording contents to a recording medium via a timer recording operation in which a recording start time, a recording end time and an input source of video signals to be recorded are set and stored in advance, comprising:
a power supply unit for supplying power to each unit of the recording and playing apparatus;
a power control unit for controlling the power supply from the power supply unit to each unit of the apparatus;
a control unit for controlling the entirety of the apparatus;
a timer unit having a clock function;
a manipulation unit; and
a memory unit; wherein
when the power control unit is set to stop the power supply from the power supply unit at the end of the timer recording operation so as to turn the power of the apparatus to an off state at the end of the timer recording operation, if an input from a user via the manipulation unit is received during the timer recording operation, the process of stopping power supply from the power supply unit via the power control unit at the end of the timer recording operation is not performed so as to maintain the power of the apparatus at an on state after the timer recording operation has ended.

2. The recording and playing apparatus according to claim 1, wherein when there is no input from the user via the manipulation unit during the timer recording operation, a screen is displayed at the end of the timer recording operation on either a display unit included in the recording and playing apparatus or a display device connected to the recording and playing apparatus to receive an instruction to maintain the power of the apparatus at an on state, and if an instruction from a user is received via manipulation of the manipulation unit within a given period of time, the power of the apparatus is maintained at an on state, and if no instruction from the user is received within the given period of time, the power of the apparatus is turned to an off state.

3. The recording and playing apparatus according to claim 1, wherein if the input from a user via the manipulation unit during the timer recording operation is the input of a power key, the setting whether to turn the power of the apparatus to an off state or to maintain the power at an on state at the end of the timer recording operation is changed according to the input of the power key, and information regarding the changed setting is displayed on either the display unit included in the recording and playing apparatus or the display device connected to the recording and playing apparatus.

4. The recording and playing apparatus according to claim 1, wherein when there is an input from a user via the manipulation unit during the timer recording operation, a selection screen enabling selection between maintaining the power to an on state or turning the power to an off state of the recording and playing device at the time the timer recording operation is ended is displayed on either the display unit included in the recording and playing apparatus or the display device connected to the recording and playing apparatus, and the power control unit controls the power supply at the time the timer recording operation is ended according to the selection performed by the user.

5. A recording and playing apparatus capable of recording contents to a recording medium via a timer recording operation in which a recording start time, a recording end time and an input source of video signals to be recorded are set and stored in advance, comprising:
a power supply unit for supplying power to each unit of the recording and playing apparatus;
a power control unit for controlling the power supply from the power supply unit to each unit of the apparatus;
a control unit for controlling the entirety of the apparatus;
a timer unit having a clock function;
a manipulation unit; and
a memory unit; wherein
when the apparatus is at a playing state at the end of the timer recording operation, the power of the apparatus is maintained at an on state by maintaining the power supply state from the power supply unit after the timer recording operation has ended, but when the apparatus is not at a playing state at the end of the timer recording operation, a screen is displayed on either a display unit included in the recording and playing apparatus or a display device connected to the recording and playing apparatus to receive an instruction to maintain the power of the apparatus at an on state, and if an instruction from a user is received via manipulation of the manipulation unit within a given period of time, the power of the apparatus is maintained at an on state, and if no instruction from the user is received within the given period of time, the power of the apparatus is turned to an off state.

6. A recording and playing apparatus capable of recording contents to a recording medium via a timer recording operation in which a recording start time, a recording end time and an input source of video signals to be recorded are set and stored in advance, comprising:
a power supply unit for supplying power to each unit of the recording and playing apparatus;
a power control unit for controlling the power supply from the power supply unit to each unit of the apparatus;
a control unit for controlling the entirety of the apparatus;
a timer unit having a clock function;
a manipulation unit; and
a memory unit; wherein
when a power key is entered during the timer recording operation, the setting on whether or not to turn the power to an off state or to maintain the power at an on state at the end of the timer recording operation is changed according to the entry of the power key, and at the same time, the information regarding the changed setting is displayed on either a display unit included in the recording and playing apparatus or a display device connected to the recording and playing apparatus, and when the apparatus is at a playing state at the end of the timer recording operation, the power of the apparatus is maintained at an on state by maintaining the power supply state from the power supply unit after the timer recording operation has ended regardless of the power setting at the end of the timer recording operation, but when the apparatus is not at a playing state at the end of the timer recording operation, the power control unit controls the power supply according to the power setting at the end of the timer recording operation.

7. The recording and playing apparatus according to claim 2, wherein if the input from a user via the manipulation unit during the timer recording operation is the input of a power key, the setting whether to turn the power of the apparatus to an off state or to maintain the power at an on state at the end of the timer recording operation is changed according to the input of the power key, and information regarding the changed setting is displayed on either the display unit included in the recording and playing apparatus or the display device connected to the recording and playing apparatus.

8. The recording and playing apparatus according to claim 2, wherein when there is an input from a user via the manipulation unit during the timer recording operation, a selection screen enabling selection between maintaining the power to an on state or turning the power to an off state of the recording and playing device at the time the timer recording operation is ended is displayed on either the display unit included in the recording and playing apparatus or the display device connected to the recording and playing apparatus, and the power control unit controls the power supply at the time the timer recording operation is ended according to the selection performed by the user.

9. The recording and playing apparatus according to claim 3, wherein when there is an input from a user via the manipulation unit during the timer recording operation, a selection screen enabling selection between maintaining the power to an on state or turning the power to an off state of the recording and playing device at the time the timer recording operation is ended is displayed on either the display unit included in the recording and playing apparatus or the display device connected to the recording and playing apparatus, and the power control unit controls the power supply at the time the timer recording operation is ended according to the selection performed by the user.

10. The recording and playing apparatus according to claim 7, wherein when there is an input from a user via the manipulation unit during the timer recording operation, a selection screen enabling selection between maintaining the power to an on state or turning the power to an off state of the recording and playing device at the time the timer recording operation is ended is displayed on either the display unit included in the recording and playing apparatus or the display device connected to the recording and playing apparatus, and the power control unit controls the power supply at the time the timer recording operation is ended according to the selection performed by the user.
